(19) United States
(12) Patent Application Publication
(10) Pub. No.: US 2026/0305721 A1
(43) Pub. Date: Oct. 8, 2026

(54) ELECTRONIC AEROSOL PROVISION SYSTEM

(71) Applicant: Nicoventures Trading Limited, London (GB)

(72) Inventors: Colin DICKENS, Southampton (GB); Catalin Mihai BALAN, Southampton (GB)

(21) Appl. No.: 19/479,863

(22) PCT Filed: Apr. 30, 2024
(86) PCT No.: PCT/GB2024/051145

§ 371 Date: Oct. 29, 2025

(30) Foreign Application Priority Data
May 3, 2023 (GB) 2306510.5

(51) Int. Cl. A24F 40/57; A24F 40/10; A24F 40/60; H05B 1/02

(52) U.S. Cl. CPC A24F 40/57; A24F 40/10; A24F 40/60; H05B 1/0225

(57) ABSTRACT

An electronic vapour provision system comprises a vaporiser for vaporising a payload for inhalation by a user of the electronic vapour provision system, a power supply for supplying power to the vaporiser to vaporise the payload in response to a user activation of the device, a cloud control input configured to receive an indication of a desired level of visible exhalate, and a control unit configured to control a power level to the vaporiser independently of the indicated desired level of visible exhalate, and adjust a duration of power to the vaporiser in dependence upon the indicated desired level of visible exhalate.

### CROSS-REFERENCE TO RELATED APPLICATIONS

This present application is a National Phase entry of PCT Application No. PCT/GB2024/051145, filed Apr. 30, 2024, which claims priority from Great Britain Application No. 2306510.5, filed May 3, 2023, each of which are fully incorporated herein by reference in their entireties.

### FIELD

The present disclosure relates to electronic aerosol provision systems such as nicotine delivery systems (e.g. electronic cigarettes and the like).

### BACKGROUND

Electronic aerosol provision systems such as electronic cigarettes (e-cigarettes) generally contain a reservoir of a source liquid containing a formulation, typically including nicotine, from which an aerosol is generated, e.g. through heat vaporisation. An aerosol source for an aerosol provision system may thus comprise a heater having a heating element arranged to receive source liquid from the reservoir, for example through wicking/capillary action. While a user inhales on the device, electrical power is supplied to the heating element to vaporise source liquid in the vicinity of the heating element to generate an aerosol for inhalation by the user. Such devices are usually provided with one or more air inlet holes located away from a mouthpiece end of the system. When a user sucks on a mouthpiece connected to the mouthpiece end of the system, air is drawn in through the inlet holes and past the aerosol source. There is a flow path connecting between the aerosol source and an opening in the mouthpiece so that air drawn past the aerosol source continues along the flow path to the mouthpiece opening, carrying some of the aerosol from the aerosol source with it. The aerosol-carrying air exits the aerosol provision system through the mouthpiece opening for inhalation by the user.

Usually an electric current is supplied to the heater when a user is drawing/puffing on the device. Typically, the electric current is supplied to the heater, e.g. resistance heating element, in response to either the activation of an airflow sensor along the flow path as the user inhales/draw/puffs or in response to the activation of a button by the user. The heat generated by the heating element is used to vaporise a formulation. The released vapour mixes with air drawn through the device by the puffing consumer and forms an aerosol. When the user has finished the puff (drop of air flow/drop of pressure) the flow or pressure sensor deactivates the electric heater by cutting off the electric current. At that point of time the heater is still at an elevated temperature capable of vaporising a certain portion of liquid. The heat for this continued vaporisation originates from the heat capacity of the heater itself. Subsequently, the heater cools down. When the temperature of the heater falls below the boiling point of the higher volatile formulation components (e.g. water, propylene glycol), the vaporisation process stalls. The vapour released during the continued vaporisation phase after deactivation is not delivered to the consumer since there is no air flow through the device anymore. Instead the vapour condenses on internal walls of the device causing potential problems (e.g. clogging). The evaporation heat released by the heater during the continued vaporisation phase can also be considered as an energy loss. The energy is lost as condensation heat which in turn is heating up structural components of the device. This issue is exacerbated in devices with larger heater elements.

Various approaches are described which seek to help address some of these issues.

### SUMMARY

According to a first aspect of certain embodiments there is provided an electronic vapour provision system in accordance with claim 1.

According to another aspect of certain embodiments there is provided a method of electronic vapour provision in accordance with claim 14.

It will be appreciated that features and aspects of the invention described above in relation to the first and other aspects of the invention are equally applicable to, and may be combined with, embodiments of the invention according to other aspects of the invention as appropriate, and not just in the specific combinations described above.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic (exploded) diagram of an electronic vapour provision system such as an e-cigarette in accordance with some embodiments of the description.

FIG. 2 is a schematic diagram of the body of the e-cigarette of FIG. 1 in accordance with some embodiments of the description.

FIG. 3 is a schematic diagram of the vaporiser portion of the e-cigarette of FIG. 1 in accordance with some embodiments of the description.

FIG. 4 is a schematic diagram showing certain aspects of one end of the body portion of the e-cigarette of FIG. 1 in accordance with some embodiments of the description.

FIG. 5 is a schematic flowchart which illustrates certain aspects of operation of the e-cigarette of FIG. 1 in accordance with some embodiments of the description.

FIG. 6 is a schematic flowchart which illustrates certain aspects of operation of the e-cigarette of FIG. 1 in accordance with some embodiments of the description.

FIG. 7 is a schematic flowchart which illustrates a method of operating an electronic vapour provision in accordance with some embodiments of the description.

FIG. 8A is a graph depicting vapour detection against power timing in accordance with some embodiments of the description.

FIG. 8B is a graph depicting accumulated vapour mass as a function of puff duration in accordance with some embodiments of the description.

FIG. 9 is a graph depicting wasted vapour as a function of puff duration in accordance with some embodiments of the description.

FIG. 10 is graph depicting accumulated vapour mass as a function of power in accordance with some embodiments of the description.

FIG. 11 is a schematic flowchart which illustrates certain aspects of operation of the e-cigarette of FIG. 1 in accordance with some embodiments of the description.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of apparatus and methods discussed herein which are not described in detail may be implemented in accordance with any conventional techniques for implementing such aspects and features.

As described above, the present disclosure relates to an aerosol provision system, such as an e-cigarette. Throughout the following description the term “e-cigarette” is sometimes used but this term may be used interchangeably with aerosol or vapour provision system.

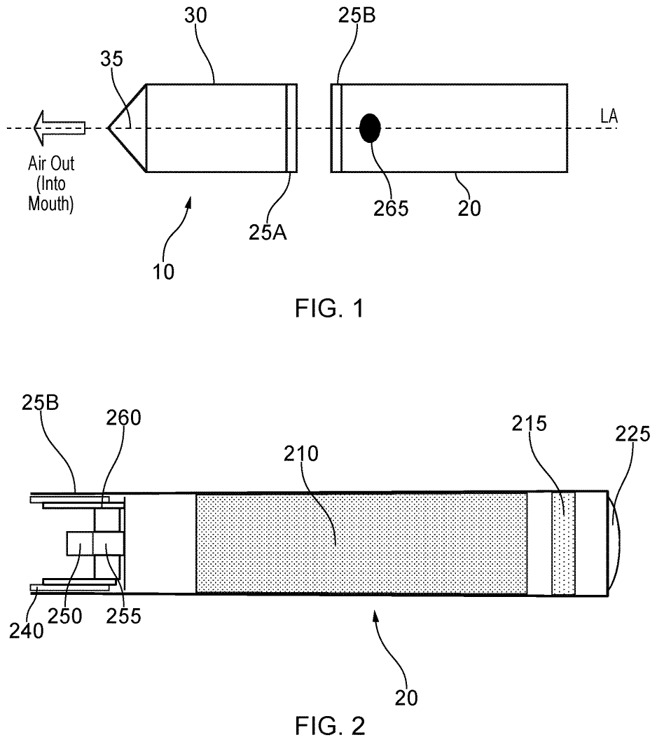

Referring now to the drawings, wherein like reference numerals designate identical or corresponding parts throughout the several views, FIG. 1 is a schematic diagram of an electronic vapour provision system ‘EVPS’ such as an e-cigarette 10 in accordance with some embodiments of the invention (not to scale). The e-cigarette has a generally cylindrical shape, extending along a longitudinal axis indicated by dashed line LA, and comprises two main components, namely a body 20 and a cartomiser 30. The cartomiser includes an internal chamber containing a reservoir of a payload such as for example nicotine, a vaporiser (such as a heater), and a mouthpiece 35. References to ‘nicotine’ hereafter will be understood to be merely exemplary and can be substituted with any suitable payload. The reservoir may be a foam matrix or any other structure for retaining the nicotine until such time that it is required to be delivered to the vaporiser. The vaporiser is for vaporising the nicotine, and the cartomiser 30 may further include a wick or similar facility to transport a small amount of nicotine from the reservoir to a vaporising location on or adjacent the vaporiser. In the following, a heater is used as a specific example of a vaporiser. However, it will be appreciated that other forms of vaporiser (for example, those which utilise ultrasonic waves) could also be used.

The body 20 includes a re-chargeable cell or battery to provide power to the e-cigarette 10 and a circuit board for generally controlling the e-cigarette. When the heater receives power from the battery, as controlled by the circuit board, the heater vaporises the nicotine and this vapour is then inhaled by a user through the mouthpiece 35. In some specific embodiments the body is further provided with a manual activation device 265, e.g. a button, switch, or touch sensor located on the outside of the body.

The body 20 and cartomiser 30 may be detachable from one another by separating in a direction parallel to the longitudinal axis LA, as shown in FIG. 1, but are joined together when the device 10 is in use by a connection, indicated schematically in FIG. 1 as 25A and 25B, to provide mechanical and electrical connectivity between the body 20 and the cartomiser 30. The electrical connector 25B on the body 20 that is used to connect to the cartomiser 30 also serves as a socket for connecting a charging device (not shown) when the body 20 is detached from the cartomiser 30. The other end of the charging device may be plugged into a USB socket to re-charge the cell in the body 20 of the e-cigarette 10. In other implementations, a cable may be provided for direct connection between the electrical connector 25B on the body 20 and a USB socket.

The e-cigarette 10 is provided with one or more holes (not shown in FIG. 1) for air inlets. These holes connect to an air passage through the e-cigarette 10 to the mouthpiece 35. When a user inhales through the mouthpiece 35, air is drawn into this air passage through the one or more air inlet holes, which are suitably located on the outside of the e-cigarette. When the heater is activated to vaporise the nicotine from the cartridge, the airflow passes through, and combines with, the nicotine vapour, and this combination of airflow and nicotine vapour then passes out of the mouthpiece 35 to be inhaled by a user. Except in single-use devices, the cartomiser 30 may be detached from the body 20 and disposed of when the supply of nicotine is exhausted (and replaced with another cartomiser if so desired).

It will be appreciated that the e-cigarette 10 shown in FIG. 1 is presented by way of example, and various other implementations can be adopted. For example, in some embodiments, the cartomiser 30 is provided as two separable components, namely a cartridge comprising the nicotine reservoir and mouthpiece (which can be replaced when the nicotine from the reservoir is exhausted), and a vaporiser comprising a heater (which is generally retained). As another example, the charging facility may connect to an additional or alternative power source, such as a car cigarette lighter.

FIG. 2 is a schematic (simplified) diagram of the body 20 of the e-cigarette 10 of FIG. 1 in accordance with some embodiments of the invention. FIG. 2 can generally be regarded as a cross-section in a plane through the longitudinal axis LA of the e-cigarette 10. Note that various components and details of the body, e.g. such as wiring and more complex shaping, have been omitted from FIG. 2 for reasons of clarity.

The body 20 includes a battery or cell 210 for powering the e-cigarette 10 in response to a user activation of the device. Additionally, the body 20 includes a control unit (not shown in FIG. 2), for example a chip such as an application specific integrated circuit (ASIC) or microcontroller, for controlling the e-cigarette 10. The microcontroller or ASIC includes a CPU or micro-processor. The operations of the CPU and other electronic components are generally controlled at least in part by software programs running on the CPU (or other component). Such software programs may be stored in non-volatile memory, such as ROM, which can be integrated into the microcontroller itself, or provided as a separate component. The CPU may access the ROM to load and execute individual software programs as and when required. The microcontroller also contains appropriate communications interfaces (and control software) for communicating as appropriate with other devices in the body 10.

The control unit is operable to estimate a user's usage timing. The usage timing may relate to the user's prior inhalation durations (puff durations) and/or the gaps between inhalations, either of which can be indicative of the duration of the next puff.

The control unit is also operable to adjust the power supplied to the vaporiser based upon the estimate. This adjustment may comprise modifying the duration of power supply to the system during a user's puff, and/or modifying the amount/level of power supplied.

The description below focusses on modifying the duration of power supply, but it will be appreciated that corresponding modifications to power levels may similarly be applied, as described later herein.

Hence in embodiments of the present description the control unit is operable to estimate a user's expected puff duration, and to cause power to be supplied to the vaporiser for a period of time shorter than the user's expected puff duration. As such, the control unit is operable to measure the length of time the user activates the device (i.e. the puff duration). Furthermore the control unit is able to store the length of time of successive puffs in the memory associated with the ASIC. The control unit may utilise the CPU to execute software programs to analyse the puff information.

In some embodiments the CPU analyses the puff information to learn an average puff duration for a user, by calculating the cumulative total duration of all puffs and dividing it by the total number of puffs. In one embodiment the total number of puffs may be limited to a certain number of puffs N, for example up to the last 100 puffs or up to the last 10 puffs. As such, the e-cigarette may be deemed responsive to changes in usage behaviour. It will be appreciated that for ‘new’ devices the user will have taken a limited number of puffs which may be less than the total number typically used to calculate an average. For such devices the total number of puffs taken will be used to calculate an average, while this number is less than the limit. Optionally, given that the memory may be used in a first-in-first out configuration (i.e. a circular configuration) to store the last N puff durations, the memory may be provided with N instances of an average puff duration pre-loaded at manufacture so that the system does not have to operate differently during initial use. Over time, these pre-loaded values are supplanted by measured values from the user. In some other embodiments the control unit learns a user's expected puff duration by employing machine learning. The CPU may be operable to employ certain software to analyse puff information, and identify trends in the user's usage behaviour. This may also be more responsive to a user's changing demands.

As noted above, the control unit is operable to cause power to be supplied to the vaporiser for a period of time shorter than the user's expected puff duration. Hence the user is most likely still puffing on the device when the supply of electric current has already been cut off. When the supply of electric current has been cut off, the heater remains at a sufficient temperature to continue to vaporise liquid for a short period of time. By causing the power to be cut off while the user is still puffing on the device, the vapour released during the continued vaporisation phase (i.e. when no power is supplied to the heater but it is still of a sufficient temperature to vaporise the liquid) can be utilised to form an aerosol inhalable by the user. This vapour fraction and the energy used to release it cannot be considered as a loss anymore. That way the energy efficiency and the number of puffs achievable with a given battery capacity can be increased. The power to the heater is cut off after being active for a time slightly shorter than the learned user puff duration. In some embodiments, the time power is supplied to the heater is between 0.05 to 0.5 seconds shorter than the expected user puff duration. In one embodiment, the time power is supplied to the heater is 0.3 seconds shorter than the expected user puff duration. In other embodiments, the time is a ratio, for example a value between 95% and 70% of the estimated duration, the ratio dropping as the estimated duration increases. This approach is discussed in more detail later herein. Alternatively or in addition, the manufacturer of a device may measure the time taken for a heating element to drop below the vapourisation temperature of the payload liquid, and use this time (or a suitable approximation thereto) as the advance cut-off time. Where different available payloads have different vapourisation temperatures, then optionally the lowest temperature (the longest advance time) may be chosen, or optionally the device may be adapted to recognise the payload type and select the appropriate cut-off time.

The body 20 further includes a cap 225 to seal and protect the far (distal) end of the e-cigarette 10. Typically there is an air inlet hole provided in or adjacent to the cap 225 to allow air to enter the body 20 when a user inhales on the mouthpiece 35. The control unit or ASIC may be positioned alongside or at one end of the battery 210. In some embodiments, the ASIC is attached to a sensor unit 215 to detect an inhalation on mouthpiece 35 (or alternatively the sensor unit 215 may be provided on the ASIC itself). An air path is provided from the air inlet through the e-cigarette, past the airflow sensor 215 and the heater (in the vaporiser or cartomiser 30), to the mouthpiece 35. Thus when a user inhales on the mouthpiece of the e-cigarette, the CPU detects such inhalation based on information from the airflow sensor 215.

At the opposite end of the body 20 from the cap 225 is the connector 25B for joining the body 20 to the cartomiser 30. The connector 25B provides mechanical and electrical connectivity between the body 20 and the cartomiser 30. The connector 25B includes a body connector 240, which is metallic (silver-plated in some embodiments) to serve as one terminal for electrical connection (positive or negative) to the cartomiser 30. The connector 25B further includes an electrical contact 250 to provide a second terminal for electrical connection to the cartomiser 30 of opposite polarity to the first terminal, namely body connector 240. The electrical contact 250 is mounted on a coil spring 255. When the body 20 is attached to the cartomiser 30, the connector 25A on the cartomiser 30 pushes against the electrical contact 250 in such a manner as to compress the coil spring in an axial direction, i.e. in a direction parallel to (co-aligned with) the longitudinal axis LA. In view of the resilient nature of the spring 255, this compression biases the spring 255 to expand, which has the effect of pushing the electrical contact 250 firmly against connector 25A of the cartomiser 30, thereby helping to ensure good electrical connectivity between the body 20 and the cartomiser 30. The body connector 240 and the electrical contact 250 are separated by a trestle 260, which is made of a non-conductor (such as plastic) to provide good insulation between the two electrical terminals. The trestle 260 is shaped to assist with the mutual mechanical engagement of connectors 25A and 25B.

As mentioned above, a button 265, which represents a form of manual activation device 265, may be located on the outer housing of the body 20. The button 265 may be implemented using any appropriate mechanism which is operable to be manually activated by the user-for example, as a mechanical button or switch, a capacitive or resistive touch sensor, and so on. It will also be appreciated that the manual activation device 265 may be located on the outer housing of the cartomiser 30, rather than the outer housing of the body 20, in which case, the manual activation device 265 may be attached to the ASIC via the connections 25A, 25B. The button 265 might also be located at the end of the body 20, in place of (or in addition to) cap 225.

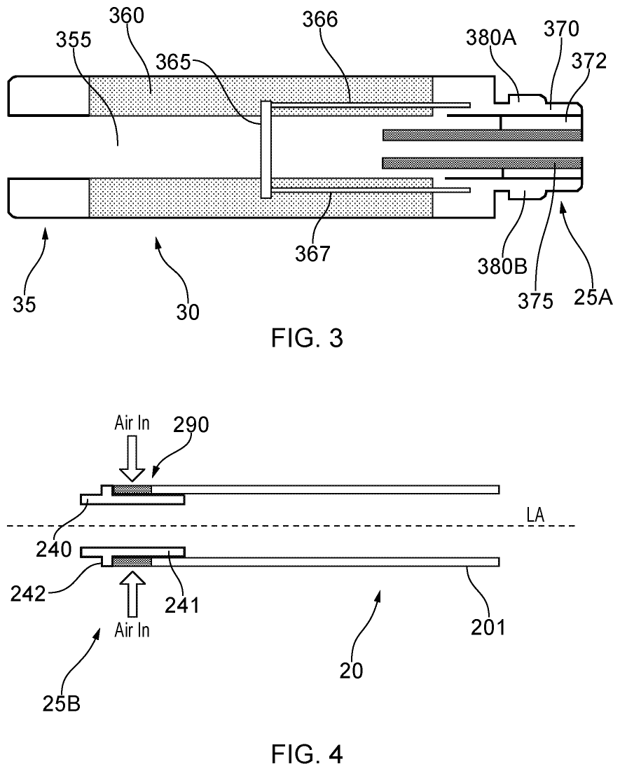

FIG. 3 is a schematic diagram of the cartomiser 30 of the e-cigarette 10 of FIG. 1 in accordance with some embodiments of the invention. FIG. 3 can generally be regarded as a cross-section in a plane through the longitudinal axis LA of the e-cigarette 10. Note that various components and details of the cartomiser 30, such as wiring and more complex shaping, have been omitted from FIG. 3 for reasons of clarity.

The cartomiser 30 includes an air passage 355 extending along the central (longitudinal) axis of the cartomiser 30 from the mouthpiece 35 to the connector 25A for joining the cartomiser 30 to the body 20. A reservoir of nicotine 360 is provided around the air passage 335. This reservoir 360 may be implemented, for example, by providing cotton or foam soaked in nicotine. The cartomiser 30 also includes a heater 365 for heating nicotine from reservoir 360 to generate nicotine vapour to flow through air passage 355 and out through mouthpiece 35 in response to a user inhaling on the e-cigarette 10. The heater 365 is powered through lines 366 and 367, which are in turn connected to opposing polarities (positive and negative, or vice versa) of the battery 210 of the main body 20 via connector 25A (the details of the wiring between the power lines 366 and 367 and connector 25A are omitted from FIG. 3).

The connector 25A includes an inner electrode 375, which may be silver-plated or made of some other suitable metal or conducting material. When the cartomiser 30 is connected to the body 20, the inner electrode 375 contacts the electrical contact 250 of the body 20 to provide a first electrical path between the cartomiser 30 and the body 20. In particular, as the connectors 25A and 25B are engaged, the inner electrode 375 pushes against the electrical contact 250 so as to compress the coil spring 255, thereby helping to ensure good electrical contact between the inner electrode 375 and the electrical contact 250.

The inner electrode 375 is surrounded by an insulating ring 372, which may be made of plastic, rubber, silicone, or any other suitable material. The insulating ring is surrounded by the cartomiser connector 370, which may be silver-plated or made of some other suitable metal or conducting material. When the cartomiser 30 is connected to the body 20, the cartomiser connector 370 contacts the body connector 240 of the body 20 to provide a second electrical path between the cartomiser 30 and the body 20. In other words, the inner electrode 375 and the cartomiser connector 370 serve as positive and negative terminals (or vice versa) for supplying power from the battery 210 in the body 20 to the heater 365 in the cartomiser 30 via supply lines 366 and 367 as appropriate.

The cartomiser connector 370 is provided with two lugs or tabs 380A, 380B, which extend in opposite directions away from the longitudinal axis of the e-cigarette 10. These tabs are used to provide a bayonet fitting in conjunction with the body connector 240 for connecting the cartomiser 30 to the body 20. This bayonet fitting provides a secure and robust connection between the cartomiser 30 and the body 20, so that the cartomiser and body are held in a fixed position relative to one another, with minimal wobble or flexing, and the likelihood of any accidental disconnection is very small. At the same time, the bayonet fitting provides simple and rapid connection and disconnection by an insertion followed by a rotation for connection, and a rotation (in the reverse direction) followed by withdrawal for disconnection. It will be appreciated that other embodiments may use a different form of connection between the body 20 and the cartomiser 30, such as a snap fit or a screw connection.

FIG. 4 is a schematic diagram of certain details of the connector 25B at the end of the body 20 in accordance with some embodiments of the invention (but omitting for clarity most of the internal structure of the connector as shown in FIG. 2, such as trestle 260). In particular, FIG. 4 shows the external housing 201 of the body 20, which generally has the form of a cylindrical tube. This external housing 201 may comprise, for example, an inner tube of metal with an outer covering of paper or similar. The external housing 201 may also comprise the manual activation device 265 (not shown in FIG. 4) so that the manual activation device 265 is easily accessible to the user.

The body connector 240 extends from this external housing 201 of the body 20. The body connector 240 as shown in FIG. 4 comprises two main portions, a shaft portion 241 in the shape of a hollow cylindrical tube, which is sized to fit just inside the external housing 201 of the body 20, and a lip portion 242 which is directed in a radially outward direction, away from the main longitudinal axis (LA) of the e-cigarette. Surrounding the shaft portion 241 of the body connector 240, where the shaft portion does not overlap with the external housing 201, is a collar or sleeve 290, which is again in a shape of a cylindrical tube. The collar 290 is retained between the lip portion 242 of the body connector 240 and the external housing 201 of the body, which together prevent movement of the collar 290 in an axial direction (i.e. parallel to axis LA). However, collar 290 is free to rotate around the shaft portion 241 (and hence also axis LA).

As mentioned above, the cap 225 is provided with an air inlet hole to allow air to flow when a user inhales on the mouthpiece 35. However, in some embodiments the majority of air that enters the device when a user inhales flows through collar 290 and body connector 240 as indicated by the two arrows in FIG. 4.

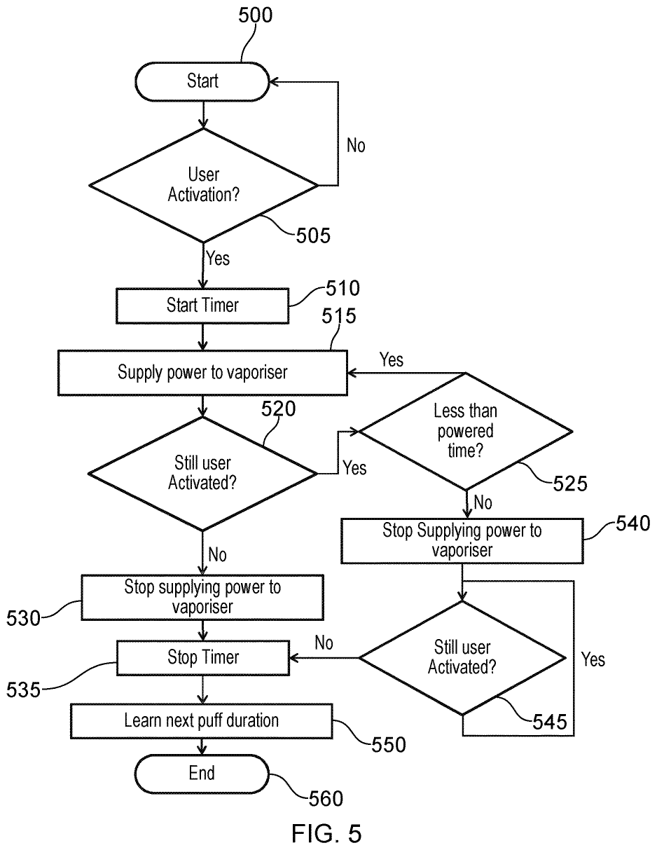

FIG. 5 shows a flow chart illustrating a process performed by the control unit for controlling operation of the electronic vapour provision system ‘EVPS’ according to some embodiments of the present description.

The process starts at step 500. At step 505, it is determined whether or not the device has been activated by the user. Activation may be by inhalation, button press or touch sensor interaction, for example. If the device has not been activated, then the process returns to the beginning of step 505. On the other hand, if the device has been activated, then the process moves onto step 510, and a timer is started to measure the total length of time the user activates the device. Immediately after, at step 515, the control unit causes power to be supplied to the vaporiser (such as heater 365). This activates the vaporiser and causes the liquid of the cartomiser 30 to be vaporised for inhalation by the user.

The process then moves onto step 520, in which it is determined whether or not the device is still being activated by the user, i.e. if the user is still inhaling, pressing the button or interacting with the touch sensor, as applicable. If it is determined at step 520 that the device is still activated, then the process moves onto step 525. At step 525, the control unit compares the current time against the first period of time (i.e. the period of time shorter than the expected puff duration, that the control unit powers the vaporiser). If the current time is less than the first period of time then the system returns to step 515 and continues to supply power to the vaporiser. A loop is formed by steps 515, 520, and 525 that can only be broken by the user deactivating the device at step 520 or if the period of activation exceeds the first period of time, at step 525. If the user deactivates the device, the system proceeds to step 530 and immediately stops supplying power to the vaporiser. Alternatively, if the period of activation exceeds the first period of time the system proceeds to step 540 and immediately stops supplying power to the vaporiser.

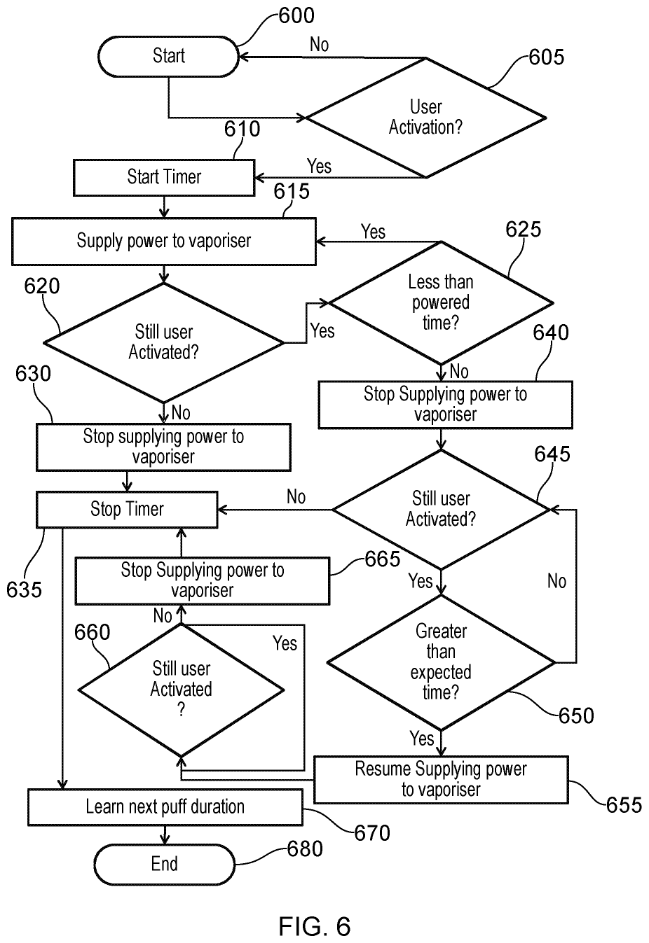

After step 530 the control unit can immediately stop the timer at step 535, so that the time measured corresponds to the length of time the device has been activated. Alternatively, after step 540, power has stopped being supplied to the vaporiser but the user is still activating the device, e.g. still puffing. As such, step 545 continuously queries whether the user has ceased to activate the device. Once the user has stopped, the system proceeds to step 535 and the timer is stopped, so that the time measured corresponds to the length of time the device has been activated. At step 550 the control unit incorporates the latest puff duration into the analysis of the expected puff duration, to estimate the user's next expected puff duration. The next step 560 ends the process and returns the device to step 500, ready for the next user activation. Note that although FIG. 6 shows the steps of starting the timer 510 and supplying power to the vaporiser 515 being performed sequentially, in practice these may be performed in parallel.

In an embodiment, the first period of time is 0.3 seconds shorter than the expected puff duration of the user. It is expected that 0.3 seconds represents a threshold time at which a user cannot detect the heater has switched off prematurely. As an example, for an expected puff duration of 3 seconds the first period of time would be 2.7 seconds. If the user presses an activation button for 2.9 seconds then 0.2 seconds of energy have been saved. Given the short period of time and the thermal inertia of the heater, liquid vaporised in this time is inhaled while no power is wasted. Furthermore as less liquid is vaporised as the temperature of the heater drops, once the user stops inhaling there will be less additional vaporisation that subsequently condenses on the internal walls of the device. As noted previously herein, other timing strategies may also be considered.

Thus, it can be seen from FIG. 5 that power is provided to the vaporiser for a period of time slightly shorter than the expected puff duration of the user, unless the user prematurely stops the puff after a time much shorter than the expected puff duration. In general terms, the vaporiser remains activated, thus vaporising the liquid, for as long as necessary so that the user does not detect a reduction in quality. This mechanism is hidden from the user and, therefore, does not require the user to practice certain behaviour in relation to the use of the device; for example releasing a button 265 early to deactivate the device prior to finishing the puff. Instead this functionality is inherent in the device, to provide a more intuitive experience. It will also be appreciated that the same approach may be used to set power levels instead of or as well as power duration to modify the delivery of an active ingredient, and also that the gaps between inhalations may similarly be measured and characterised to identify a correlation between gap duration and active ingredient demand. This latter approach may be useful for example once the system starts to change either the power duration and/or level, as this may affect the inhalation duration due to the change in delivery (whether consciously or unconsciously on the part of the user), so making the inhalation durations atypical, but the gaps between durations are unaffected inasmuch as they are influenced by the user's wish to consumed further active ingredient.

However, the embodiment detailed in FIG. 5 has the potential, in some circumstances, to provide an unsatisfactory user experience, particularly in the case that the power duration is curtailed, but potentially also when less vapour is being generated due to a lower power level. If the actual user puff duration exceeds the estimated (expected) user puff duration greatly, then the user may detect a significant loss of performance in the final stage of the puff (and/or it is symptomatic of the user not experiencing the desired puff). To overcome this issue some embodiments of the device are further configured to resume supplying power to the vaporiser, in response to a longer than expected puff, for a second period of time.

Accordingly FIG. 6 shows a flow chart illustrating a process performed by the control unit for controlling operation of the electronic vapour provision system ‘EVPS’ according to some embodiments of the present description, wherein the system is further configured to resume supplying power to the vaporiser in response to a longer than expected puff.

The process starts at step 600. At step 605, it is determined whether or not the device has been activated by the user (again for example by inhalation, button press or touch sensor interaction). If the device has not been activated, then the process returns to the beginning of step 605. On the other hand, if the device has been activated, then the process moves onto step 610, and a timer is started to measure the total length of time the user activates the device. Immediately after, at step 615, the control unit causes power to be supplied to the vaporiser (such as heater 365). This activates the vaporiser and causes the liquid of the cartomiser 30 to be vaporised for inhalation by the user.

The process then moves onto step 620, in which it is determined whether or not the device is still being activated by the user. If it is determined at step 620 that the device is still activated, then the process moves onto step 625. At step 625, the control unit compares the current time against the first period of time (i.e. the period of time shorter than the expected puff duration that the control unit powers the vaporiser). If the current time is less than the first period of time then the system returns to step 615 and continues to supply power to the vaporiser. A loop is formed by steps 615, 620, and 625 that can only be broken by the user deactivating the device at step 620 or the period of activation exceeding the first period of time, at step 625. If the user deactivates the device, the system proceeds to step 630 and immediately stops supplying power to the vaporiser. Alternatively, if the period of activation exceeds the first period of time the system proceeds to step 640 and immediately stops supplying power to the vaporiser.

After step 630 the control unit can immediately stop the timer at step 635, so that the time measured corresponds to the length of time the device has been activated. Alternatively, after step 640, power has stopped being supplied to the vaporiser but the user is still activating the device, i.e. still puffing. As such, step 645 queries whether the user has ceased to activate the device. If the user is not activating the device, the control unit proceeds to step 635 and the timer is stopped, so that the time measured corresponds to the length of time the device has been activated. If the user is still activating the device, the control unit proceeds to step 650 and the control unit queries whether the current time is greater than the expected puff duration. If the current time is not greater, the system loops back to step 645. If, however the current time is greater, the system proceeds to step 655 and the control unit resumes supplying power to the vaporiser. At step 660 the system continuously queries whether the user has ceased to activate the device. Once the answer is no the system proceeds to step 665 and the control unit stops supplying power to the vaporiser. Next the control unit proceeds to step 635 and the timer is stopped, so that the time measured corresponds to the length of time the device has been activated by the user. At step 670 the control unit incorporates the latest puff duration into the analysis of the expected puff duration, to estimate the next puff duration. The next step 680 ends the process and returns the device to step 600, ready for the next user activation. It will be appreciated that the above approach may equally supply power at a first level for the expected time, and if the user is still activating the device at that point, proceed to supply power at a higher level. When combining both approaches, e.g. resuming after a cut-off, the resumed power level may either be the same as before (since it is still more than nothing) or be at a higher level on the assumption that it was not sufficient beforehand.

However, different embodiments may adopt different approaches to the power management of the heater. The embodiment of FIG. 6 powers the heater for a first period of time, slightly shorter than the expected puff duration, and then resumes powering the heater for a second period of time if the user activation of the device exceeds the expected puff duration. In one embodiment, rather than resume at the same or a higher power level as suggested above, it may be advantageous to resume powering the heater for the second period of time at a lower power level, thereby reducing the continued vaporisation phase after the user deactivates the device.

In an alternate embodiment, the power may be pulsed repeatedly during the second period while the user continues to activate the device. For an equivalent period of time, the integrated energy supplied by the pulses will be significantly less than the integrated energy supplied by the power level of the first period of time. In either of these embodiments the energy usage is reduced, enhancing the number of puffs that can be achieved per battery, whilst also ensuring that the performance of the device is not noticeably reduced. Additionally by reducing the length of the continued vaporisation phase, there is less condensation of vapour on the internal walls of the device. In certain embodiments, the control unit may not completely stop powering the heater after the first period, and instead may immediately start pulsing power to the heater or may immediately power the heater at a lower power for the second period of time. The thermal inertia of the heater will be slowly reduced; however this will not occur as quickly as if the heater were powered off and therefore if the user activates the device for a larger than expected time they are less likely to notice a loss of performance.

As previously mentioned, some embodiments may adopt implementations of a manual activation device 265 rather than, for example, airflow sensor 215. The manual activation device may be activated by the user to cause the control unit to supply power to the vaporiser to vaporise the liquid. In these embodiments the user activation of the manual activation device facilitates the user activation of the device, thereby starting the processes described above, for example in FIG. 5 and FIG. 6. The manual activation device 265 may be, for example, a physical button or switch or may be a touch sensor (such as a resistive or capacitive touch sensor) which is activated simply by being touched by the user. In addition, the method of activating and deactivating the manual activation device 265 may also take a range of different approaches. For example, in some cases the manual activation device may be activated for a predetermined period of time after the button 265 is pressed or touched, after which the manual activation device is de-activated. Such an implementation helps to ensure that the manual activation device is de-activated by the user, although the user does not have full (direct) control over the supply of power to the vaporiser.

In some embodiments, the manual activation device 265 comprises a button which is activated by a first press of the button by the user, and then deactivated by a second (subsequent) press of the button by the user. In other words, alternate presses of the button activate and then deactivate the manual activation device. During the time period between the first and second press, the microcontroller regards the manual activation device 265 as activated. This method has the advantage of providing the user with direct control over the duration of activation, although the manual activation device may remain activated if the user forgets or neglects to make a second press. In another example, the manual activation device 265 is deemed activated for as long as the button is continuously pressed by the user. This method again gives the user control over how long the vaporiser is activated. Moreover, it is natural for a user to stop pressing the button 265 when they have finished using the e-cigarette, so it is unlikely that the manual activation device would remain in an activated state unintentionally.

Similar methods may also be adopted when the manual activation device 265 comprises a touch sensor. That is, in one example, the manual activation device 265 is deemed to be activated following a first touch of the touch sensor by the user and then deemed to be deactivated following a second touch of the touch sensor by the user. During the time period between the first and second touch, the manual activation device 265 is deemed activated. In another example, the manual activation device 265 is deemed activated for as long as the touch sensor is continuously touched by the user.

In another example, if the manual activation device 265 comprises a manual switch, such as a slidable or rotatable switch, then the manual activation device 265 will be activated when the switch is put into an “on” position and deactivated when the switch is put into an “off” position. In such embodiments, the switch may be biased towards the “off” position so that the user has to continually hold the switch in the “on” position in order for the manual activation device to be activated. In this case, when the user stops holding the switch in the “on” position, the switch will automatically return (under the influence of a spring or some other resilient bias mechanism, etc) to the “off” position. This not only makes it more difficult for the switch to be unintentionally retained in the “on” (activated) position, but also makes it easier for the user, since the user does not have to manually change the switch back to the “off” position after inhaling on the e-cigarette.

The manual activation device 265, be it a button, touch sensor, switch or any other suitable device, is generally positioned such that it is easily accessible to the user when the user holds the e-cigarette 10 so as to inhale on it. For example, the manual activation device 265 may be located somewhat closer to the proximal (mouth) end of the e-cigarette than to the distal (cap) end of the e-cigarette, since the user is more likely to hold the e-cigarette closer at a position closer to its proximal end (as is the case for conventional combustible cigarettes). Thus in the example shown in FIG. 1, the button 265 is located on the body portion 25 (since the cartridge 30 is disposable), but at the end nearest to the mouthpiece. The button may be activated (pressed, moved or touched) conveniently while the e-cigarette is being held by a user. While the manual activation devices have been described in-depth with regard to the activation of the device and consequently the vaporiser, it will be appreciated that in many embodiments additional manual activation devices may serve ancillary functions, for example an on/off or lock switch.

In alternate embodiments, an air flow sensor may be implemented in the device so that the user may activate the device and cause the control unit to supply power to the vaporiser to vaporise the liquid by inhaling on the device. In these embodiments the user activation of the air flow sensor facilitates the user activation of the device, thereby starting the processes described above, for example in FIG. 5 and FIG. 6. The body 20 includes the sensor unit 215 located in or adjacent to the air path through the body 20 from the air inlet to the air outlet (to the vaporiser). The sensor unit 215 may include a pressure drop sensor and temperature sensor (also in or adjacent to this air path). It will be appreciated, however, that the sensor unit 215 may include the pressure drop sensor without the temperature sensor or may include an airflow monitor to directly measure airflow (rather than pressure drop). Thus when a user inhales on the mouthpiece of the e-cigarette, the control unit detects such inhalation based on information from the pressure drop sensor. In response to the detection of an inhalation, the CPU supplies power to the heater, which thereby heats and vaporises the nicotine from the wick for inhalation by the user.

Hence it will be appreciated that ‘activation’ and ‘deactivation’ may equally be considered separate actions (such as pushing a button or switch on and then off) or the commencement and cessation of a single action (such as inhalation, pressing a button or interacting with a touch sensor).

Advantageously, the above described embodiments act to reduce the energy supplied to the heater during each puff. As such, this may increase the number of puffs for a given battery capacity or present an opportunity to reduce the battery capacity of the device. The reduced length of the continued vaporisation phase additionally reduces unwanted condensates on the internal walls of the device, improves puff count for a given volume of liquid, and may also help to alleviate carbonyl build up, which occurs when the heater is on but there is no airflow in the device.

The above techniques have been described primarily with reference to estimating the puff duration, but it has been noted that that the same approach is applicable to estimating the period between puffs, e.g. during an ongoing session as described elsewhere herein.

The above techniques were also described primarily with reference to providing means by which an electronic vapour provision system ‘EVPS’ may learn a user's puff behaviour and modify the duration of power supply to the system during a user's puff, but it was also noted that the same approach is applicable to modifying the power level supplied to the system.

Hence more generally, in embodiments of the present description an electronic vapour provision system comprises a vaporiser for vaporising a payload for inhalation by a user of the electronic vapour provision system (as described elsewhere herein) and a power supply for supplying power to the vaporiser to vaporise the payload in response to a user activation of the device (as described elsewhere herein); and furthermore comprises a control unit configured to estimate a user's usage timing (whether activation duration and/or gaps, as described elsewhere herein); and adjust the power supplied to the vaporiser based upon the estimate (whether duration and/or level, as described elsewhere herein).

In embodiments of the present description, the control unit is configured to measure an actual usage timing of the user (whether the user's inhalation duration and/or the gap between inhalations) and compare the actual usage timing and the estimated usage timing, and adjust the power supplied to the vaporiser based upon a difference between the actual and estimated usage timings; e.g. whether the actual and estimated usage timings differ by more than a predetermined amount.

In relation to the usage timing being a user's vaporiser activation duration, as described elsewhere herein, then in one instance the control unit is configured to increase the power level to the vaporiser to supply more vapour, if the measured actual timing of the user exceeds the estimate by a predetermined amount. Conversely in another instance the control unit is configured to decrease the power level to the vaporiser to supply less vapour, if the measured actual timing of the user is less than the estimate by a predetermined amount.

These two instances reflect that there is a positive relationship between vaporiser activation duration and user demand for vapour.

In these two instances, optionally and as noted elsewhere herein, for example with reference to FIGS. 5 and 6, the control unit may optionally also be configured to cause power to be supplied to the vaporiser for a period of time shorter than the estimated usage timing.

Meanwhile in relation to the usage timing being a period between vaporiser activations, then in one instance the control unit is configured to increase the power to the vaporiser to supply more vapour, if the measured actual timing of the user is less than the estimate by a predetermined amount. Conversely in another instance the usage timing is a period between vaporiser activations by the user, the control unit is configured to decrease the power to the vaporiser to supply less vapour, if the measured actual timing of the user is more than the estimate by a predetermined amount.

These two instances reflect that there is an inverse relationship between the duration of gaps between inhalations and demand for vapour.

In these two instances, optionally the usage timing is a period between vaporiser activations by the user within a predetermined range consistent with an ongoing usage session and not a period of cessation between sessions; in other words, the inter-activation timings are assumed to be whilst the user is actively consuming vapour from the system (e.g. as if smoking a single cigarette) and not, for example a period when the device has been put away or otherwise removed from ongoing use.

Since the system compares the actual timing of the user with an estimate, typically in these embodiments the adjustment of the power to the vaporiser is implemented for the next user activation of the device, since the information about whether the actual timing is greater or smaller than the estimate can only be determined after the fact (at least when the actual timing is greater).

Whether the usage timing relates to the user's vaporiser activation duration or the period between vaporiser activations, the predetermined amount by which the timing exceeds or is less than the estimate may be selected based on calculating the standard deviation associated with the mean of the N prior events (previously measured timings, e.g. puffs or gaps) where as noted previously herein N is typically a number between 10 and 100. Then in embodiments of the description, optionally the predetermined amount is a certain number of standard deviations from the mean (whether fractional, e.g. ½ SD or ¾ SD) or equal to or larger than 1 SD (e.g. 1 SD, 1½ SDs or 2 SDs). This approach allows the system to effectively calibrate to the behaviour of the user and detect when that behaviour is out of the norm, indicating that the user is either experiencing sufficient desire for the active ingredient that it has altered their behaviour by this measureable extent, or conversely the user is sufficiently sated that it has altered their behaviour by this measureable extent.

Whether the usage timing relates to the user's vaporiser activation duration or the period between vaporiser activations, and whether the response involves modifying the duration of the power supply and/or the level of the power supply, optionally the control unit may be configured to estimate the user's usage timing responsive to one or more contextual factors external to the electronic vapour provision system, in order to improve the estimate, since such factors may affect how the user uses the system.

Hence for example the control unit may be configured to estimate the user's usage timing responsive to one or more selected from the list consisting of a current time of day or a current day of the week (either of which may result in, for example more relaxed or more urgent inhalation patterns of use), a current location (which for example may impose time limits on use or different types of behaviour), identities of one or more people nearby, and (for example as a proxy for those people, or for locations) identities of one or more devices nearby (for example using Bluetooth® identifiers), since a user may behave differently with family, friends, or strangers, or as noted above in different locations, including mobile locations such as a car.

As noted previously herein, optionally as an alternative to compiling statistics such as a rolling average and optionally standard deviation, the control unit may employ machine learning software to learn a user's expected activation duration.

Also as noted previously herein, optionally the control unit may be further configured to resume causing power to be supplied to the vaporiser for a second period of time, if the user activates the device for a duration exceeding the user's expected timing, the second period of time ending when the user ceases activation of the device. During this period the power level may be the same as before, higher (to help sate the user) or lower (to help reduce condensation), depending on the relative significance of these considerations to the designer.

As noted earlier herein, in embodiments of the present description the above techniques may set the power supply time as a ratio or proportion of the expected inhalation time; for example a value between 95% and 70% of the estimated duration, the ratio dropping as the estimated duration increases.

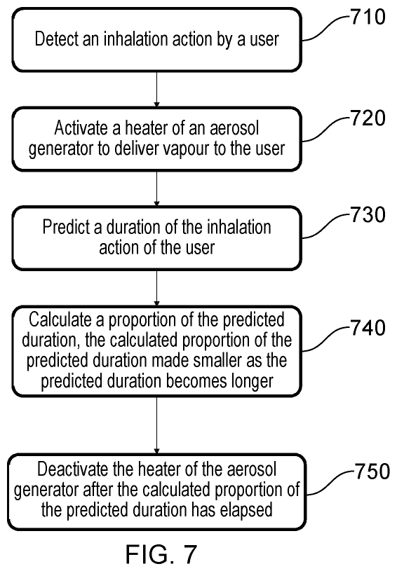

Hence referring now also to FIG. 7, in an embodiment of the present description, a method of vapour delivery for an electronic vapour provision system comprises the following steps:
In a first step 710, detecting an inhalation action by a user; as noted elsewhere herein, this may be done for example using an airflow sensor 215.
In a second step 720, activating a heater of an aerosol generator to deliver vapour to the user, as described elsewhere herein.
In a third step 730, predicting a duration of the inhalation action of the user, as described elsewhere herein.
In a fourth step 740, calculating a proportion of the predicted duration (as non-limiting examples, between 70 and 95% of the predicted duration) as described elsewhere herein.
In a fifth step 750, deactivating the heater of the aerosol generator after the calculated proportion of the predicted duration has elapsed, as described elsewhere herein;
and wherein the calculated proportion of the predicted duration is made smaller as the predicted duration becomes longer.

This latter point reflects conflicting efficiencies within an inhalation action.

Firstly, it will be appreciated that there is a substantially fixed period at the start of an inhalation action in which power is supplied to the heater, but it has not yet reached a vaporisation temperature. This non-productive period can be thought of as an overhead on the delivery of vapour to the user, and is proportionally larger for short duration inhalations. As a result, regular short inhalations are power-inefficient in terms of vapour mass delivery to the user.

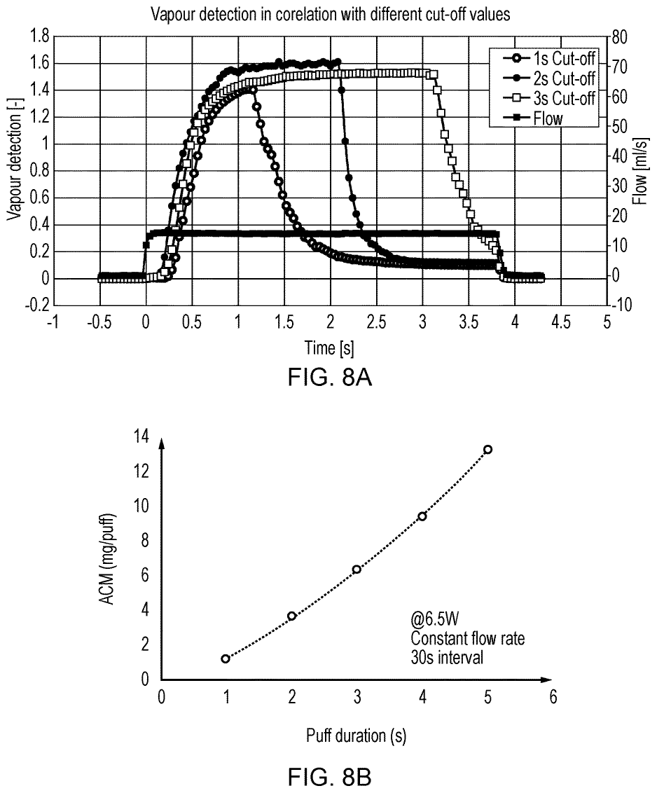

As shown in FIG. 8A (which shows time on the x-axis and vapour detection on a left y-axis and flow on a right y-axis), for a constant inhalation air flow (the primarily horizontal sequence corresponding to a flow of 15 m/s), the rate of initial vapour detection is roughly similar for all inhalations, since all share the same initial heater profile, taking typically 0.5 to 0.7 seconds from heater activation to reach full output.

In FIG. 8A, the heater is then cut off after each of one, two, and three seconds from activation. It will be appreciated that in the case of a one second cut off, the heater had only just reached full output before being disabled whilst the two second and three second sessions each had at least some period of full output.

Referring now also to FIG. 8B, this results a non-linear relationship between puff duration and accumulated vapour mass (‘ACM’ in FIG. 8B). This figure shows the committed vapour mass generated for different durations of puff for the same heater power (6.5W), after successive 30 second intervals to ensure full cooling of the heater.

Consequently in principle it would be desirable to keep the heater turned on for as long as possible during a short inhalation in order to maximise the vapour mass delivered to the user; this would improve the ratio of battery power to vapour mass production over the course of a usage session, and hence extend the usage time of the device whilst delivering the desired overall vapour mass.

Secondly, it will be appreciated that there is a substantially fixed period at the end of an inhalation action in which after power is no longer supplied to the heater, it is still above the vaporisation temperature of the payload, and so additional vapour may be produced after inhalation airflow has ceased. This un-inhaled vapour can be thought of as an overhead on the delivery of vapour to the user, and again is proportionally larger for short duration inhalations. As a result regular short duration inhalations in particular are payload-inefficient in terms of vapour mass delivery to the user. Meanwhile for any duration of inhalation it represents some inefficiency and can also cause problems if some or all of the generated vapour then condenses inside the device.

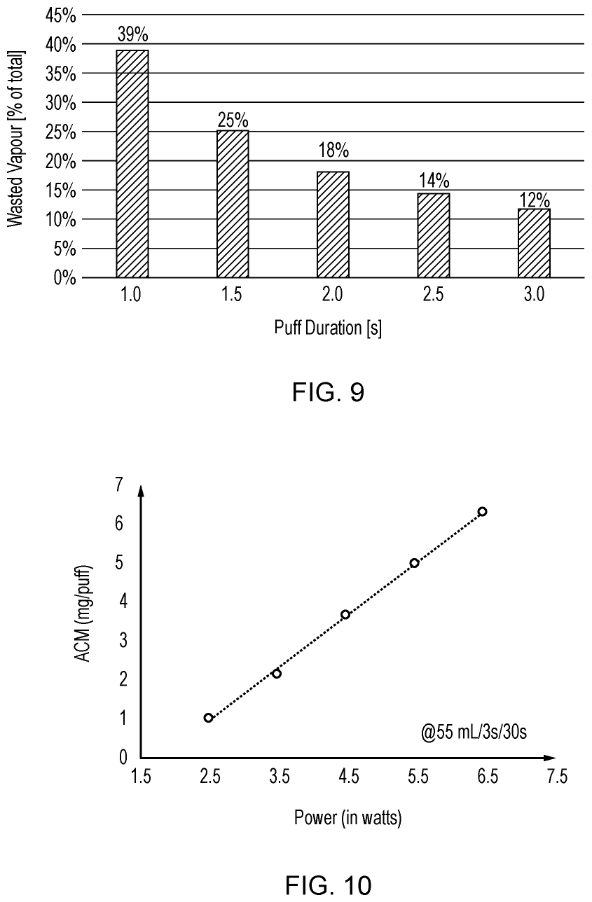

As shown in FIG. 9, like the battery overhead at the start of inhalation, this vapour overhead at the end of inhalation has a non-linear relationship with inhalation duration, representing a larger proportion of the vapour generated for short puffs than for long puffs.

Consequently in principle it would be desirable to turn the heater off for a brief period before the end of the inhalation, so that the vapour generated by the residual heat of the heater can still be usefully inhaled by the user.

However, it will be appreciated that this approach to improve vapour delivery contradicts the desirable approach for improving battery usage, particularly for short inhalation periods.

Accordingly, in embodiments of the present invention, and as noted elsewhere herein, having predicted a duration of inhalation action of the user, an electronic vapour provision system calculates a proportion of that predicted duration after which the heater is deactivated, wherein the calculated proportion of the predicted duration is made smaller as the predicted duration becomes longer.

Hence, as non-limiting examples, for a short predicted inhalation (for example 1 second) the proportion may be 95%, whereas for a long predicted inhalation (for example 6 seconds) the proportion may be 70%. The proportion may vary linearly or non-linearly with duration, and may be bracketed in that the proportion may reach a maximum value at a predetermined short period (as a non-limiting example 1 second), and may reach a minimum value at a predetermined long period (as a non-limiting example 6 seconds).

The predetermined maximum proportion may be 95%, 90%, 85%, or 80%, or values in between, whilst the predetermined minimum proportion may be 70%, 65%, 60%, 55%, or 50%, or values in between.

Notably the maximum proportion is less than 100%; hence there is always an attempt to cut off the heater before the predicted duration has elapsed, in order to attempt to extract vapour generated during the highest residual temperature period after the heater has been deactivated, which will be when a disproportionate amount of the residual vapour is generated. Optionally, the difference in time between the calculated proportion of the predicted duration and the predicted duration itself corresponds to no less than a time taken for the heater to drop below a vaporisation temperature for the delivered vapour; that is to say, the maximum proportion percentage may be calculated to provide enough time for the heater to drop to (or just below) the vaporisation temperature of the payload.

Meanwhile the minimum proportion is significantly lower than the maximum; for example there may be a 20%, 25% or 30% gap between the minimum and maximum proportions in any one implementation of the technique. The minimum proportion provides improved battery efficiency and vapour efficiency in the latter part of an inhalation, and empirically it has been observed that users do not notice a tail-off in the production of vapour at the end of a longer inhalation, possibly because the mouth and potentially the airways are already thoroughly infused with the vapour.

Consequently the above approach provides a means of improving vapour delivery efficiency for different inhalation durations, taking account of the differing and completing efficiencies for battery use as a function of vapour mass, and unconsumed vapour mass, which become particularly problematic for short inhalation durations.

Another aspect of vapour delivery efficiency as a function of battery use is the power level supplied to the heater; referring now to FIG. 10, for an identical inhalation profile, the ratio of power to accumulated vapour mass (‘ACM’) improves (becomes more efficient) as power increases. This is essentially because a certain proportion of the power is raising the temperature of the heating element to the vaporisation temperature, whilst the remaining proportion of the power is raising the temperature further to create vapour; hence for example a power 1.5 W may result in no vapour at all as the heater does not reach the vaporisation temperature; meanwhile a 40% increase in power from 2.5 W to 3.5 W may result in a 100% increase in accumulated vapour mass. This disproportionate benefit reduces as the proportion of the delivered power accounting for preheat temperatures reduces, and by close to around 6 to 7 watts, the increase in power results in a closely corresponding increase in vapour.

Accordingly, in terms of vapour delivery efficiency as a function of battery use, it is preferable to use a higher power level where possible. It will be appreciated however that there may be reasons for choosing a different battery power level, for example extending the duration of use, or maintaining battery lifetime. Hence in embodiments of the present description, the heater optionally may be supplied with power at a level being one selected from the list consisting of within 30%, 20% or 10% of maximum, or at maximum power. If the battery is running low on power, then the effective maximum power may of course drop.

Since the power level is likely to affect the rate of vapour generation, then optionally in this case the calculated proportion of the predicted duration may be modified responsive to the level of power supplied, with the capitated proportion being overall smaller as the power goes higher, or conversely being overall longer as the selected power drops below maximum. Of course, this may be subject to the caveat of an overall maximum proportion such as 95%.

Techniques for predicting the duration of inhalation have been discussed elsewhere herein, for example in terms of learning an average puff duration, or training a machine learning system to predict a puff duration.

Hence for example the predicted duration of the inhalation action of the user may be responsive to one or more selected from the list consisting of an average of a predetermined number of preceding inhalation actions, as described elsewhere herein; a duration of an inhalation action at a corresponding period within a prior sequence of inhalation actions (in other words a duration characteristic of a duration envelope for a particular sequence such as the consumption of a virtual cigarette); and a duration of a corresponding inhalation action within a predetermined pattern of inhalation actions (similar to the second example, but not necessarily time-based but rather pattern-based, for example where inhalation is a function of habit).

Alternatively or in addition the predicted duration of the inhalation action of the user may be responsive to an initial inhalation airflow gradient (for example during the first 0.1. 0.2, 0.3, 0.4, or 0.5 seconds after inhalation is detected). In other words, the rate at which airflow increases at the start of an inhalation is indicative of how rapidly the user's lungs will inflate. Since these have a finite capacity (and the user's maximum can be determined from an integral of the airflow among prior inhalations), then the initial gradient of the airflow is a strong indicator of both the type of inhalation being conducted (e.g. hard & fast or relaxed & slow) and hence also its duration (based on time to maximum capacity, or maximum typically inhaled amount).

It will be appreciated that the gradient detection can also be combined with the other techniques to improve the estimate. For example, using one or more gradient thresholds, averages can be maintained for different classes of gradient so that each average is a more accurate estimate of the duration for that particular type of inhalation. Similarly, the gradients can be used to characterise patterns or sequences within a puff session, and to estimate where the user is within a session (or identify the session type) for example using correlation between a current sequence of initial gradients (or their thresholded classification) and a stored sequence.

In any event, once the duration of the inhalation action of the user has been predicted, the proportion of the predicted duration may be calculated using any of the techniques described herein, including one or optionally more selected from the list consisting of using a predetermined linear relationship between predicted duration and proportion, as described elsewhere herein, using a predetermined non-linear relationship between predicted duration and proportion, as described elsewhere herein, and using a look-up table providing proportion values for respective predicted durations based on the closest table entry to the predicted duration, which provides a piece-wise or quantised implementation of either the linear or non-linear relationship, but simplifies the calculation by storing the results in advance.

The above techniques use conventional statistics to estimate averages, patterns, thresholds, and relationships between the various parameters discussed herein to predict the inhalation duration and the proportion thereof in which to power the heater. However, optionally one or both of these calculations may be learned by a machine learning algorithm.

Hence in embodiments of the present description, the step of predicting the duration of the inhalation action of the user may use a machine learning algorithm, trained on a training set comprising one or more initial parameters of inhalation actions as inputs and the corresponding overall duration of the inhalation actions as the target output. The inputs may comprise for example one or more average values, pattern positions, initial airflow gradients, or other statistical information about the inhalation (e.g. current target power level set for the heater, and/or battery level, and/or a standard deviation associated with any averages provided). The target outputs are the actual inhalation durations observed. It will be appreciated that a machine learning system can be pre-trained prior to use by a particular user (for example based on usage data acquired by a developer of the device) and optionally different models may be trained for different demographics (e.g. using gender and/or height as a proxy for lung capacity and any behavioural differences) so that the initial estimates are suited to the user. However optionally the system may then continue to learn for the actual user, based on the observed inhalation durations during use.

Similarly, the step of calculating a proportion of the predicted duration may use a machine learning algorithm, trained on a training set comprising durations of inhalation actions as inputs and proportion values as the target output. In this case the input durations may be the estimated durations of inhalation, as this will be the information available from the preceding step. Meanwhile the target output comprises the proportion value. Optionally the target output may include both the proportion value and the eventually observed inhalation duration, so that the machine learning system can learn to predict any patterns relating to systemic inaccuracies in estimation (for example the estimate may become less accurate in terms of absolute time for longer inhalations) when estimating the proportion of time.

Optionally in addition to at least the proportion value, the target output may further include a user satisfaction/dissatisfaction value, indicating whether the user was satisfied with the inhalation when the heater was activated for the proportion of the estimated inhalation duration indicated by the proportion value. These values may be acquired by the developer during test uses of the device. Subsequently the user themselves may provide an input indicating dissatisfaction with the delivery of vapour so that the machine learning system can learn to calculate a modified proportion of subsequent predicted durations responsive to the input.

It will be appreciated that this feedback approach of receiving a user input indicating dissatisfaction with the delivery of vapour may be used to calculate a modified proportion of subsequent predicted durations responsive to the input for any other techniques herein, for example modifying the linear, nonlinear, or tabulated relationship between the predicted duration and the proportion of saturation during which the heater is activated.

As noted above, machine learning systems may be trained for different user demographics. Similarly, machine learning systems may alternatively or in addition be trained for different respective models of electronic vapour provision system, as these may have different heating profiles, different airflow pathways, and the like; and also for different payloads, as these may produce different qualities of vapour, have different vaporisation temperatures, and/or different concentrations of active ingredient, which may contrary to different inhalation behaviours and different acceptable heating proportions during an inhalation.

The above techniques relate primarily to battery and/or payload efficiency during use of the electronic vapour provision system ‘EVPS’, based at least in part upon an estimate of how long the current puff by the user will last. However, there are further aspects of the puff that can be adapted in light of the above techniques.

In particular, it would be desirable to allow the user to control the level or amount of cloud (visible exhalate) generated during a puff. This may be for example to accommodate a social situation, so as to reduce visible signs of use.

Since the level or amount of cloud is typically a function of the amount of payload generated during the puff, the above techniques for controlling payload vapourisation can also influence the level of cloud generation.

Accordingly, and referring again to FIGS. 1-4, then in addition to the above approaches regarding battery and/or payload efficiency—or alternatively, if those techniques are not used for those purposes—an electronic vapour provision system ‘EVPS’ may comprise the following:
a vaporiser for vaporising a payload for inhalation by a user of the electronic vapour provision system, as described elsewhere herein;
a power supply for supplying power to the vaporiser to vaporise the payload in response to a user activation of the device, as described elsewhere herein;
a cloud control input configured to receive an indication of a desired level of visible exhalate, as described below; and
a control unit configured to:
control a power level to the vaporiser independently of the indicated desired level of visible exhalate, as described below; and
adjust a duration of power to the vaporiser in dependence upon the indicated desired level of visible exhalate, as described below.

Hence the system does not use the power level to control cloud generation-as noted elsewhere herein, lower power levels are more inefficient, and so this will impact battery life.

Instead, the system uses a duration of power (i.e. the duration of power at a level that causes vaporisation) to generate the desired level of visible exhalate (cloud).

Hence typically the control unit is configured to set the same power level for vaporisation for successive inhalation actions of the user, even if the user indicates a different level of visible exhalate for different inhalation actions. Obviously, the power level may change for other reasons independent of this technique.

Similarly, typically the control unit is configured to set a constant power level for vaporisation during a main sequence of an inhalation action of the user; here the main sequence during a vaporisation stage of the inhalation (i.e. when the heater is at or above a vaporisation temperature of the payload). Power supplied before or after this stage may also be at the constant level or may ramp up or down, for example to protect the battery or the heater for sudden discharges, or thermal shocks.

As noted previously herein, higher power levels are more efficient, and so typically the control unit is configured to set a power level in a top range of power levels available to the electronic vapour provision system. The may for example be a power level selected from the list consisting of within the top 50% available power levels, within the top 25% available power levels, within the top 10% available power levels, and the maximum available power level.

Hence more generally the a control unit is configured to control a power level to the vaporiser independently of the indicated desired level of visible exhalate, where typically that power level is set to increase battery efficiency by being in an upper range of power levels during vaporisation (e.g. the upper 50% or more preferably 25%, 10% or top level).

As noted above, rather than use the power level to alter the cloud generation, the control unit is configured to set a duration for providing power to vaporise the payload in dependence upon the indicated desired level of visible exhalate. The control unit is then configured to cause the power to vaporise the payload to stop at the set duration, even if the user is still inhaling on the electronic vapour provision system.

Hence the system generates an amount of vapour expected to result in the desired level of exhalate by generating vapour for a calculated period of time that is responsive to the indicated desired level of visible exhalate. The system then stops generating vapour, even if the user is still inhaling.

In this way, the desired level of visible exhalate can be controlled while maintaining battery efficiency, while the user themselves does not need to consciously adjust their own behaviour to achieve the desired level.

Clearly however, it is possibly that the user may wish to inhale more vapour that is provided by the above technique for a particular individual puff. Consequently, optionally the control unit is configured to cause the power to vaporise the payload to resume if the user continues to inhale for more than a predetermined period after the control unit stopped the power. This allows for the supply of vapour to resume if there is a risk of a noticeable non-delivery of vapour to the user. The predetermined period may for example be 0.25, 0.5, 1, or 1.5 seconds later. Referring again to FIG. 8A, a typical predetermined period may be around 0.5 seconds, as this is when vapour levels have dropped detectably. However, the predetermined period may also change depending on the length of time that has been calculated as required for the level of visible exhalate, for example using the same principles described previously herein for cutting off power for shorter or longer puffs. Hence for a shorter initial vaporisation period, the predetermined period may be shorter than for a longer initial vaporisation period.

In the event that the control unit resumes power, the optionally the control unit may be configured to cause the power to vaporise the payload to resume at a lower power level than the level previously stopped. In this case the use of power will be less efficient, but is likely to be for a fairly short amount of time (the residual inhalation time after the main vapour generation period and the predetermined period after that); the purpose of using a lower power level is to generate less vapour and so less cloud. In this way the amount of excess cloud visible exhalate over that indicated as desired is reduced compared to what would be generated at a higher power.

In this way, the user can set their device to produce a desired level of visible exhalate (e.g. due to circumstances such as how enclosed an area is, or the lack of a breeze, or social constraints) but if they inhale for significantly longer than is needed to generate that visible exhalate, then the system (having cut the vapour off), is then configured to provide them with apparently desired additional supply of vapour, but optionally at a compromise power level that does not produce as much excess visible exhalate over and above that already budgeted for by the system.

The amount of visible exhalate can be indicated by the user via any suitable user interface; this may for example be ‘more’ and ‘less’ buttons (physical or virtual), or a cloud slider (again physical or virtual), or icons indicating several different cloud sizes. The interface(s) could be provided on the EVPS, or, in virtual form, on a display of a mobile phone paired or otherwise operably coupled to the EVPS (for example via Bluetooth®).

Hence it may not be necessary for the user to provide a numerical value representative of the actual volume of cloud exhaled (though this could be provided), but rather an indication of more or less than current, or a position on a sliding scale of options or out of a set of chosen options.

### Variant Embodiments

The above system uses a fixed power setting and a calculated timing to generate the amount of vapour that will result in the desired level of visible exhalate.

However, as noted elsewhere herein, timing for the power supplied to the vaporiser may be calculated based on a prediction of the duration of the inhalation, for other efficiency reasons.

If the timing is calculated for one of these other reasons, then the power level may be calculated to generate the correct amount of vapour to produce the indicated amount of visible exhalate over the time calculated to power on the heater.

Hence if the predicted time (and hence the heater cut off time) is short, then a higher power level may be needed to generate the indicated level of visible exhalate in the vaporisation time available. Conversely if the predicted time (and hence the heater cut off time) is long, then a lower power level may be needed to generate the indicated level of visible exhalate in the vaporisation time available.

Where these requirements conflict, a failover state may be used. Hence for example where the predicted time and cut off time are so long that the required power level would be below a preferred level, or when the predicted time and cut off time are so short that the required power level would be above a maximum level, then the system may either operate at the minimum preferred level/maximum level (as applicable), accepting that too much or too little visible exhalate will be produced, or optionally stop attempting to generate the indicated level of visible exhalate at all and just revert to a standard generation process (for example based on one of the power and/or payload efficiency techniques described elsewhere herein).

Hence in an embodiment of the present description, the control unit may be configured to estimate a user's usage timing, and adjust the power supplied to the vaporiser based upon the estimate, as described elsewhere herein.

Similarly in an embodiment of the present description, the electronic vapour provision system may comprise a sensor configured to detect an inhalation action by a user, a duration processor configured to predict a duration of the inhalation action of the user, and a proportion processor configured to calculate a proportion of the predicted duration, as described elsewhere herein, and the control unit may be configured to deactivate the vaporiser after the calculated proportion of the predicted duration has elapsed, wherein the proportion processor is configured to make the calculated proportion of the predicted duration smaller as the predicted duration becomes longer, as described elsewhere herein.

Optionally, the control unit adjusts the power level if the calculated proportion of the predicted duration is too long or too short to generate the vapour in dependence upon the indicated desired level of visible exhalate at the current power level, as described above.

It will be appreciated that the above techniques may be carried out on hardware (such as in FIGS. 1-4 and as described elsewhere herein) suitably adapted as applicable by software instruction or by the inclusion or substitution of dedicated hardware.

Thus the required adaptation to existing parts of a conventional equivalent device may be implemented in the form of a computer program product comprising processor implementable instructions stored on a non-transitory machine-readable medium such as a floppy disk, optical disk, hard disk, solid state disk, PROM, RAM, flash memory or any combination of these or other storage media, or realised in hardware as an ASIC (application specific integrated circuit) or an FPGA (field programmable gate array) or other configurable circuit suitable to use in adapting the conventional equivalent device. Separately, such a computer program may be transmitted via data signals on a network such as an Ethernet, a wireless network, the Internet, or any combination of these or other networks.

The computer program may thus provide means to implement a method of electronic vapour provision according to the principles described herein.

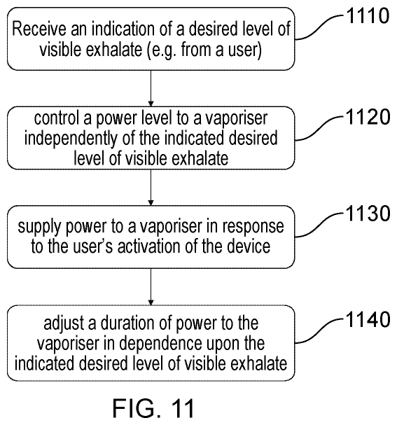

Referring now to FIG. 11, in an summary embodiment, such a method of electronic vapour provision comprises the following steps.
In a first step 1110, receive an indication of a desired level of visible exhalate (e.g. from a user), as described elsewhere herein;
In a second step 1120, control a power level to a vaporiser (for vaporising a payload for inhalation by the user) independently of the indicated desired level of visible exhalate, as described elsewhere herein;
In a third step 1130, supply power to a vaporiser in response to the user's activation of the device, as described elsewhere herein; and
In a fourth step 1140, adjust a duration of power to the vaporiser in dependence upon the indicated desired level of visible exhalate, as described elsewhere herein.

It will be apparent to a person skilled in the art that variations in the above method corresponding to operation of the various embodiments of the apparatus as described and claimed herein are considered within the scope of the present invention, including but not limited to that:
the same power level is set for vaporisation for successive inhalation actions of the user, as described elsewhere herein;
a constant power level is set for vaporisation during a main sequence of an inhalation action of the user, as described elsewhere herein;
a power level is set in a top range of power levels available to an electronic vapour provision system providing the vapour, as described elsewhere herein;
   in this instance, optionally the power is set at a level selected from the list consisting of within the top 50% available power levels, within the top 25% available power levels, within the top 10% available power levels, and the maximum available power level, as described elsewhere herein;
the method comprises setting a duration for providing power to vaporise the payload in dependence upon the indicated desired level of visible exhalate, and causing the power to vaporise the payload to stop at the set duration, even if the user is still inhaling on the electronic vapour provision system, as described elsewhere herein;
the method comprises causing the power to vaporise the payload to resume if the user continues to inhale for more than a predetermined period after causing the power to stop, as described elsewhere herein;
   in this instance, optionally the power to vaporise the payload resumes at a lower power level than the level previously stopped, as described elsewhere herein;
the method comprises detecting by a sensor an inhalation action by the user, predicting a duration of the inhalation action of the user, calculating a proportion of the predicted duration, and deactivating the vaporiser after the calculated proportion of the predicted duration has elapsed, wherein the calculated proportion of the predicted duration is made smaller as the predicted duration becomes longer, as described elsewhere herein;
   in this instance, the method optionally comprises adjusting the power level if the calculated proportion of the predicted duration is too long or too short to generate the vapour in dependence upon the indicated desired level of visible exhalate at the current power level, as described elsewhere herein; and
the method comprises estimating the user's usage timing, and adjusting the power supplied to the vaporiser based upon the estimate, as described elsewhere herein.

In order to address various issues and advance the art, this disclosure shows by way of illustration various embodiments in which the claimed invention(s) may be practiced. The advantages and features of the disclosure are of a representative sample of embodiments only, and are not exhaustive and/or exclusive. They are presented only to assist in understanding and to teach the claimed invention(s). It is to be understood that advantages, embodiments, examples, functions, features, structures, and/or other aspects of the disclosure are not to be considered limitations on the disclosure as defined by the claims or limitations on equivalents to the claims, and that other embodiments may be utilised and modifications may be made without departing from the scope of the claims. Various embodiments may suitably comprise, consist of, or consist essentially of, various combinations of the disclosed elements, components, features, parts, steps, means, etc. other than those specifically described herein, and it will thus be appreciated that features of the dependent claims may be combined with features of the independent claims in combinations other than those explicitly set out in the claims. The disclosure may include other inventions not presently claimed, but which may be claimed in future.

1. An electronic vapour provision system comprising:
a vaporiser for vaporising a payload for inhalation by a user of the electronic vapour provision system;
a power supply for supplying power to the vaporiser to vaporise the payload in response to a user activation of the device;
a cloud control input configured to receive an indication of a desired level of visible exhalate; and
a control unit configured to:
control a power level to the vaporiser independently of the indicated desired level of visible exhalate; and
adjust a duration of power to the vaporiser in dependence upon the indicated desired level of visible exhalate.

2. The electronic vapour provision system according to claim 1, in which:
the control unit is configured to set a same power level for vaporisation for successive inhalation actions of the user.

3. The electronic vapour provision system according to claim 1, in which:
the control unit is configured to set a constant power level for vaporisation during a main sequence of an inhalation action of the user.

4. The electronic vapour provision system according to claim 1, in which:
the control unit is configured to set a power level in a top range of power levels available to the electronic vapour provision system.

5. The electronic vapour provision system according to claim 4, in which:
the control unit is configured to set the power level selected from the list consisting of:
i. within the top 50% available power levels;
ii. within the top 25% available power levels;
iii. within the top 10% available power levels; and
iv. the maximum available power level.

6. The electronic vapour provision system according to claim 1, in which:
the control unit is configured to set a duration for providing power to vaporise the payload in dependence upon the indicated desired level of visible exhalate; and
the control unit is configured to cause the power to vaporise the payload to stop at the set duration, even if the user is still inhaling on the electronic vapour provision system.

7. The electronic vapour provision system according to claim 6, in which:
the control unit is configured to cause the power to vaporise the payload to resume if the user continues to inhale for more than a predetermined period after the control unit stopped the power.

8. The electronic vapour provision system according to claim 7, in which:
the control unit is configured to cause the power to vaporise the payload to resume at a lower power level than the level previously stopped.

9. The electronic vapour provision system according to claim 1, further comprising:
a sensor configured to detect an inhalation action by the user;
a duration processor configured to predict a duration of the inhalation action of the user;
a proportion processor configured to calculate a proportion of the predicted duration; and
the control unit is configured to deactivate the vaporiser after the calculated proportion of the predicted duration has elapsed; wherein:
the proportion processor is configured to make the calculated proportion of the predicted duration smaller as the predicted duration becomes longer.

10. The electronic vapour provision system according to claim 9, in which:
the control unit is configured to adjust the power level if the calculated proportion of the predicted duration is too long or too short to generate the vapour in dependence upon the indicated desired level of visible exhalate at the current power level.

11. The electronic vapour provision system according to claim 1, in which:
the control unit is configured to:
i. estimate the user's usage timing; and
ii. adjust the power supplied to the vaporiser based upon the estimate.

12. A method of electronic vapour provision, comprising steps of:
receiving an indication of a desired level of visible exhalate;
controlling a power level to a vaporiser, for vaporising a payload for inhalation by a user, independently of the indicated desired level of visible exhalate;
supplying power to the vaporiser in response to the user's activation of a device; and
adjusting a duration of power to the vaporiser in dependence upon the indicated desired level of visible exhalate.

13. The method according to claim 12, in which a same power level is set for vaporisation for successive inhalation actions of the user.

14. The method according to claim 12, in which a constant power level is set for vaporisation during a main sequence of an inhalation action of the user.

15. The method according to claim 12, in which a power level is set in a top range of power levels available to an electronic vapour provision system providing the vapour.

16. The method according to claim 15, in which the power is set at a level selected from the list consisting of:
i. within the top 50% available power levels;
ii. within the top 25% available power levels;
iii. within the top 10% available power levels; and
iv. the maximum available power level.

17. The method according to claim 12, comprising the steps of:
setting a duration for providing power to vaporise the payload in dependence upon the indicated desired level of visible exhalate; and
causing the power to vaporise the payload to stop at the set duration, even if the user is still inhaling on the electronic vapour provision system.

18. The method according to claim 17, further comprising the step of:
causing the power to vaporise the payload to resume if the user continues to inhale for more than a predetermined period after causing the power to stop.

19. The method according to claim 18, in which:
the power to vaporise the payload resumes at a lower power level than the level previously stopped.

20. The method according to claim 12, comprising the steps of:
detecting by a sensor an inhalation action by the user;
predicting a duration of the inhalation action of the user;
calculating a proportion of the predicted duration; and
deactivating the vaporiser after the calculated proportion of the predicted duration has elapsed; wherein:
the calculated proportion of the predicted duration is made smaller as the predicted duration becomes longer.

21. The method according to claim 20, further comprising the step of:
adjusting the power level if the calculated proportion of the predicted duration is too long or too short to generate the vapour in dependence upon the indicated desired level of visible exhalate at the current power level.

22. The method according to claim 12, further comprising the steps of:
estimating the user's usage timing; and
adjusting the power supplied to the vaporiser based upon the estimate.
